(19) United States
(12) Patent Application Publication
(10) Pub. No.: US 2021/0042007 A1
(43) Pub. Date: Feb. 11, 2021

(54) NAVIGABLE TOOLTIP

(71) Applicant: HEWLETT PACKARD ENTERPRISE DEVELOPMENT LP, Houston, TX (US)

(72) Inventor: Prakash Shanmugam Damodaran, Chennai (IN)

(21) Appl. No.: 16/531,808

(22) Filed: Aug. 5, 2019

(51) Int. Cl. G06F 3/0481; G06F 3/0482; G06F 3/0489; G06F 3/0485

(52) U.S. Cl. CPC G06F 3/04812; G06F 3/0482; G06F 3/0485; G06F 3/04897; G06F 3/04892

(57) ABSTRACT

Systems and methods are provided for implementing navigable tooltips. One method may include displaying an image in a graphical user interface, wherein the image comprises one or more markers; responsive to detecting a cursor hovering over one of the markers, displaying a tooltip over a portion of the image, wherein the tooltip includes a plurality of tabs and a content panel, and wherein displaying the tooltip comprises displaying first content related to a first one of the tabs in the content panel; and responsive to detecting the cursor hovering over a second one of the tabs, displaying second content related to the second one of the tabs in the content panel.

### DESCRIPTION OF RELATED ART

The disclosed technology relates generally to graphical user interfaces, and more particularly some embodiments relate to tooltips for such interfaces.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 represents an image displayed by a graphical user interface according to embodiments of the disclosed technology.

FIG. 2 is a block diagram of an example computing component or device for implementing navigable tooltips according to embodiments of the disclosed technology.

FIG. 3 represents the image of FIG. 1 when a tooltip is displayed according to embodiments of the disclosed technology.

FIG. 4 illustrates the image and tooltip of FIG. 3 when a second tab is selected according to embodiments of the disclosed technology.

FIG. 5 illustrates the image and tooltip displayed when another marker is selected according to embodiments of the disclosed technology.

FIG. 6 illustrates an example where a user may switch tabs by simply moving the cursor to hover over a different marker according to embodiments of the disclosed technology.

FIG. 7 illustrates the image and tooltip of FIG. 6 after a user has operated the tab control according to embodiments of the disclosed technology.

FIG. 8 illustrates the tooltip of FIG. 7, with the addition of an action button according to embodiments of the disclosed technology.

FIG. 9 is an example computing component that may be used to implement various features of embodiments described in the present disclosure.

The figures are not exhaustive and do not limit the present disclosure to the precise form disclosed.

### DETAILED DESCRIPTION

A tooltip is a small pop-up window that appears over an image in a graphical user interface when a cursor hovers over a marker in the image that is linked to the tooltip. The tooltip displays information related to the marker. Some tooltips include an action button such as a “close” button.

Embodiments of the disclosed technology provide navigable tooltips. That is, in contrast to conventional tooltips, the disclosed tooltips may be navigated by a user to display additional information that is not currently displayed in the tooltip. For example, the tooltip may include a plurality of tabs and a content panel. The user may select any of the tabs by hovering a cursor over the selected tab. Additional content related to the selected tab may then appear in the content panel. What a user selects another tab, additional content related to the newly-selected tab may replace the content previously displayed in the content panel.

One benefit of tooltips is their small size, which obscures only a small portion of the image being displayed. In some cases, a marker may be related to more tabs than can be displayed simultaneously in a tooltip. To enable a user to navigate to these unseen tabs, the tooltip may also include a tab control that enables the user to view additional tabs, for example by scrolling the tabs through the tooltip. The user may then select one of the newly-displayed tabs to view content related to that tab in the content panel.

In some embodiments, the image may include a plurality of related items, and each tab may represent one of the items. The content related to each tab may include data associated with the item represented by the tab. Such embodiments allow the user to view content for multiple related items in a single tooltip. In some embodiments, the data associated with the items varies along a common dimension, and each marker represents a value of that dimension. For example, the items in the image may represent communication network links, the data may represent the performance of the network links, and the dimension may represent time. In this example, each marker may represent a particular time, and the tooltip related to a marker may display network link performance data for the time represented by the marker. In particular, each tab may display network performance data for one of the network links at the time represent a by the marker. This example is described in detail below. However, it should be appreciated that the disclosed tooltips may present any data for any item and dimension.

Embodiments of the disclosed technology provide numerous technical advantages. Through the use of the disclosed tooltip tabs, the disclosed tooltips provide the user with far more information than conventional tooltips. Each tab may be selected to view content associated with that tab. The total viewable content provided by these tabs is far greater than that provided by a conventional tooltip. Furthermore, the disclosed tooltips may provide more tabs than can be viewed at once in the tooltip. To enable selecting all of the tabs, and vieweing the associated content, the tabs may be scrollable. That is, tabs that are shown in the tooltip may be replaced with other tabs that were not shown using a scrolling mechanism. In this manner, content associated with many tabs may be viewed in a single tooltip.

Some embodiments of the disclosed technology provide further technical advantages. In these embodiments, the tabs may be related by a dimension, for example such as time. The tabs in a displayed tooltip may contain content that is related to a value of the dimension. For example, all of the tabs in a displayed tooltip may contain content related to the same time. When invoked, for example by selecting a marker, the tooltip may intelligently select a default tab, and display the content associated with that default tab. For example, when multiple markers are shown for a particular time, the default tab may be related to the marker selected. These and other technical advantages are described in detail below.

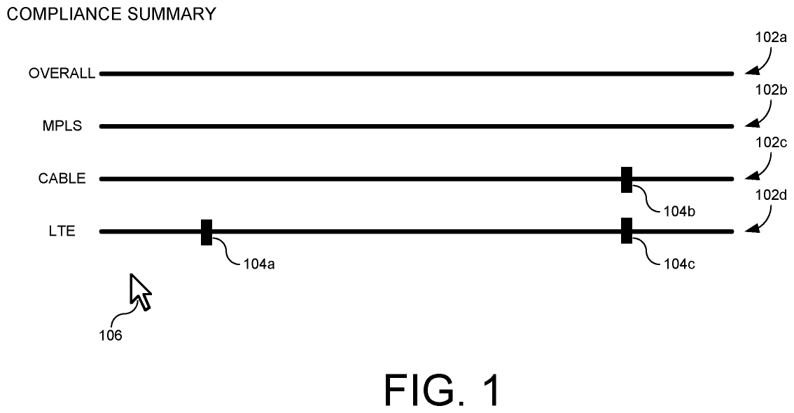

FIG. 1 represents an image displayed by a graphical user interface according to embodiments of the disclosed technology. In the example of FIG. 1, the image represents a graph of the performance of several network links over time. But in other embodiments, the image may represent other representations of other data. Referring to FIG. 1, the image includes a plurality of items 102. Each item 102 represents a network link or group of links. In particular, item 102b represents a Multiprotocol Label Switching (MPLS) protocol network link, item 102c represents a cable network link, item 102d represents a Long-Term Evolution (LTE) network link, and item 102a represents all of the network links 102. The image also includes a plurality of markers 104 displayed in particular positions on the items 102. In this example, the items 102 represent a particular time period, and the positions of the items 102 represent particular times during the period. In the image, the representation of time progresses from left to right. For example, the markers 104b,c represent a later time than the marker 104a.

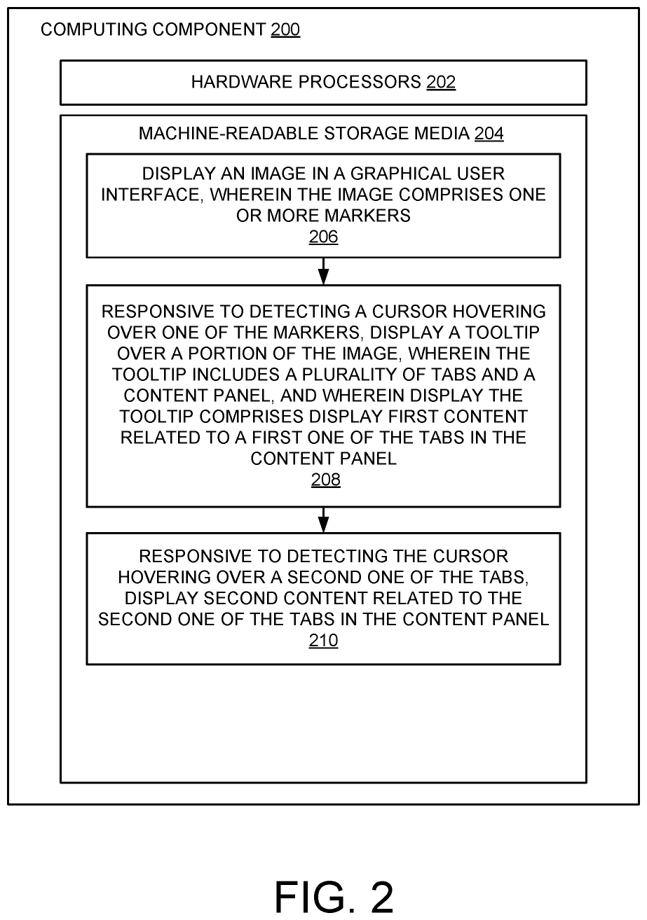

FIG. 2 is a block diagram of an example computing component or device 200 for implementing navigable tooltips according to embodiments of the disclosed technology. Computing component 200 may be, for example, a server computer, a controller, or any other similar computing component capable of processing data. In the example implementation of FIG. 2, the computing component 200 includes a hardware processor 202, and machine-readable storage medium 204.

Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-210, to control processes or operations for practicing embodiments of the disclosed technology. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-210. Depending on the implementation, the instructions may include additional, fewer, or alternative instructions, and may be performed in various orders or in parallel.

Hardware processor 202 may execute instructions 206 to display an image in a graphical user interface. The image may comprise one or more markers. For example, referring to FIG. 1, the image includes three markers 104a,b,c. To indicate that the markers 104 are graphical elements that may be used to invoke navigable tooltips, the markers 104 may be displayed with a special appearance. For example, the markers 104 may have a certain shape to indicate they are active elements. In the example of FIG. 1, the markers 104 have a rectangular shape. As another example, the markers 104 may have a particular color that contrasts with other colors in the image. For example, the markers 104 may have an orange color when the color orange does not appear elsewhere in the image.

In some embodiments, the markers 104 may be fixed in the image. For example, a designer of the image may set the markers at particular positions, from which they cannot be moved. In such embodiments, only data related to those positions is required by the tooltips. Data need not be provided for positions in the image that are not associated with one of the markers 104. In these embodiments, only a small amount of tooltip data is required. The tooltip data may be stored in a small file associated with the image file.

In some embodiments, users may move the markers 104 to different locations in the image. For example, referring to FIG. 1, users may slide the markers 104 to new positions along the timelines 102, delete existing markers 104, and add new markers 104. In such embodiments, tooltip data is provided for any location where a marker 104 could be placed. In these embodiments, a large set of tooltip data may be stored in a relational database that is associated with the image. The locations of the markers 104 may represent indexes to be applied to the database. The indexes may represent a position along the dimension of the item. In the example of FIG. 1, the dimension is time, and the indexes may represent particular times along the timelines 102. When a marker 104 is placed at a particular position along a timeline 102, the time represented by that position may be used to index the relational database. When the cursor 106 is hovered over that marker 104, the indexed data may be retrieved from the relational database, and may be displayed in the content panel 310 of the tooltip. Hardware processor 202 may execute instructions 208 to display a tooltip over a portion of the image. The tooltip may be displayed responsive to detecting the cursor hovering over one of the markers in the image. The tooltip may include a plurality of tabs and a content panel. Displaying the tooltip may comprise displaying first content related to a first one of the tabs in the content panel.

Detecting the cursor hovering over a marker may be implemented in many ways. For example, locations of the markers may be stored in file. Positions of the cursor may be compared to the locations in the file. When a position of the cursor coincides with the location of the marker, that marker is selected, and the tooltip for that marker is displayed.

In some embodiments, the cursor must hover over a marker for a minimum determined time before that marker is selected. In such embodiments, the timer may be started when the position of the cursor coincides with the location of a marker. When the position of the cursor changes before the timer expires, the marker is not selected. But when the timer expires before the position of the cursor changes, the marker is selected, and a corresponding tooltip is displayed.

In some embodiments, the location of the marker coincides in size and shape with the displayed marker. In these embodiments, the position of the cursor must lie within the displayed marker to select that marker. In other embodiments, the stored boundaries of the marker may exceed the boundaries of the displayed marker. In these embodiments, a marker may be selected when the cursor hovers near the marker. Such embodiments make it easier to select a marker, and may be used to improve accessibility. In other embodiments, the boundaries of the displayed marker may exceed the stored boundaries of the marker. In such embodiments, the cursor must hover near the center of a displayed marker to select that marker. Such embodiments make it more difficult to select a marker, and may be used when for example many markers are displayed in close proximity.

The displayed position of the tooltip may be selected in any manner. For example, the position may be selected to be a given distance from the related marker 104. As another example, the position may be selected so that the tooltip does not obscure the related marker 104. In some embodiments, a line may be displayed that connects the tooltip with the related marker 104 so it is clear to which marker the tooltip refers.

The displayed size of the tooltip may be selected in any manner. For example, the size of the tooltip may be selected according to factors such as the number of tabs the tooltip contains, the amount of data to be shown in the content panel, the size of the image, fonts used, and the like. In some embodiments, the size of all of the tooltips may be the same, for example to produce a consistent experience for the user. in other embodiments, the tooltip size may vary, for example in accordance with the number of tabs each tooltip contains, the amount of data to be displayed in the content panel, and the like.

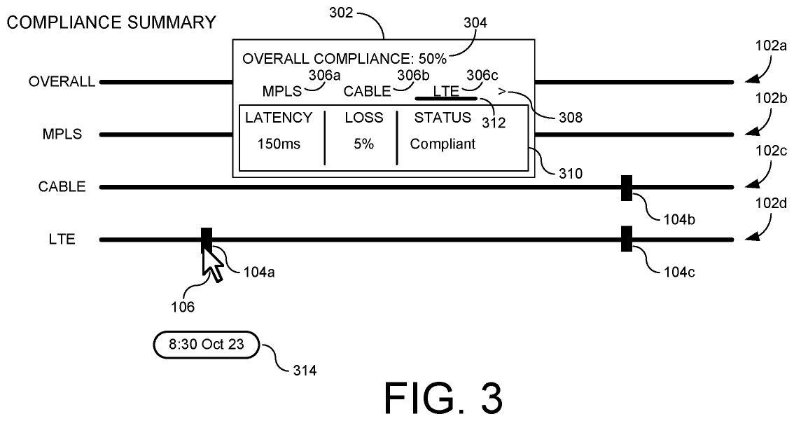

FIG. 3 represents the image of FIG. 1 when a tooltip is displayed according to embodiments of the disclosed technology. Referring to FIG. 3, the user has caused a cursor 106 to hover over one of the markers 104a, for example by manipulating a pointing tool such as a mouse, trackball, touchscreen, or the like. Responsive to the cursor 106 hovering over the marker 104a, a tooltip 302 is displayed. The tooltip 302 may include a plurality of tabs 306 and a content panel 310. In the example of FIG. 3, each of the tabs 306 represents one of the items 102 in the image. In some embodiments, the tabs 306 appear In the tooltip in the same order that the items 102 appear in the image. In particular, the tabs 306a,b,c represent the items 102b,c,d, respectively. The tooltip 302 may include other items, for example such as a tooltip title or summary 304. In the example of FIG. 3, a tooltip summary 304 is shown as “OVERALL COMPLIANCE: 50%.”

In some embodiments, one of the tabs 306 is selected automatically for the user when the tooltip 302 is generated. In such embodiments, the tab 306 selected may be the tab 306 representing the item 102 associated with the selected marker 104. In the example of FIG. 3, the selected tab 104a is associated with the LTE item 102d. Therefore, the LTE tab 306c is selected. In some embodiments, the selected tab 306 may be indicated by an indicator 312 in the image. In the example of FIG. 3, the indicator 312 indicates that the LTE tab 306c is selected. Moreover, content related to the selected LTE tab 306c is displayed in the content panel 310. In the example of FIG. 3, the content includes performance data for the LTE link represented by the LTE item 102d. In particular, the content indicates a latency of 150 milliseconds, a loss of 5%, and a status of “Compliant.”

In some embodiments, the value of the dimension represented by the selected marker 104 may also be displayed. In the example of FIG. 3, the dimension is time, and the time value for the selected marker 104a is displayed at 314. In the example of FIG. 3 that time and date is shown as “8:30 Oct 23.”

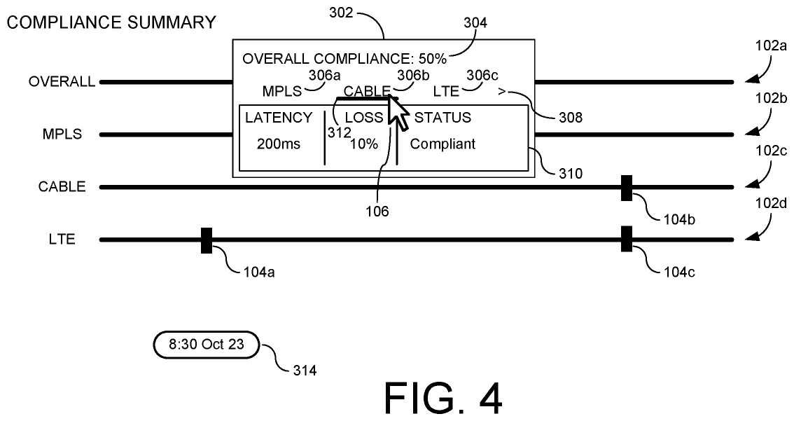

Hardware processor 202 may execute instructions 210 to display second content related to a second one of the tabs in the content panel responsive to detecting the cursor hovering over a second one of the tabs. FIG. 4 illustrates the image and tooltip of FIG. 3 when a second tab is selected according to embodiments of the disclosed technology. Referring to FIG. 4, a user has manipulated the cursor 106 to hover over the CABLE tab 306b, thereby selecting that tab. In the described embodiments, markers and tabs are selected by hovering a cursor. But in other embodiments, the markers and/or tabs may be selected by clicking the cursor, for example by hovering the cursor while pressing a button on a mouse, trackball, or the like. Other methods of selection may be used instead, or in additions to, these methods.

Responsive to the CABLE tab 306b being selected, the indicator 312 may appear at that tab to indicate the selected tab to the user. Moreover, content related to the CABLE tab 306b may appear in the content panel 310. In the example of FIG. 4, the content includes performance data for the CABLE link represented by the CABLE item 102c. In particular, the content indicates a latency of 200 milliseconds, a loss of 10%, and a status of “Compliant.”

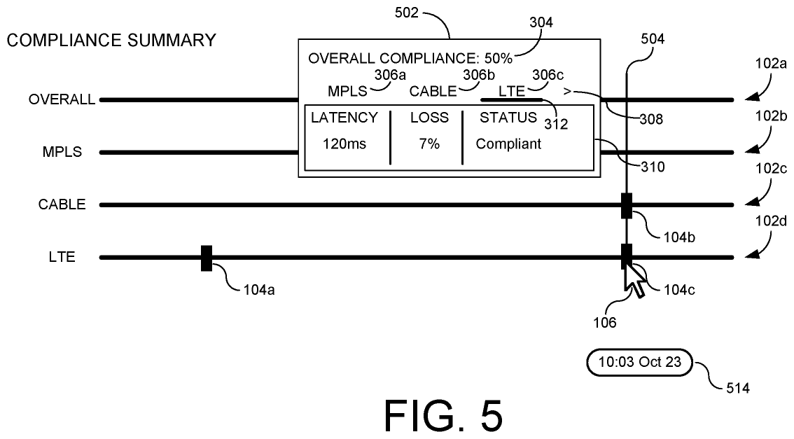

The user may subsequently select a different marker 104. FIG. 5 illustrates the image and tooltip displayed when another marker is selected according to embodiments of the disclosed technology. Referring to FIG. 5, the user has selected the marker 104c, which like marker 104a is also displayed on the LTE item 102d, but which represents a later time that marker 104a. The time value for the selected marker 104c is displayed at 514. In the example of FIG. 5 that time and date is shown as “10:03 Oct 23.”

Furthermore, responsive to the marker 104c being selected, a tooltip 502 for that marker is displayed. Because the marker 104c is related to the LTE item 102d, the LTE tab 306c is selected by default, as indicated by the indicator 312. Moreover, content related to the LTE item 102d is displayed in the content panel 310. In particular, the content indicates a latency of 120 milliseconds, a loss of 7%, and a status of “Compliant.” In some embodiments, an “anchor line” is displayed for markers that represent the same time, to indicate the data points and time indicated by the tooltip 502. In the example of FIG. 5, an anchor line 504 connects the markers 104b,c, which represent the same time, and which have data shown in the tooltip 502. The tooltip 502 includes data for all of the items 102. But when the cursor 106 hovers over one of the items 102, that item's tab 306 is selected by default.

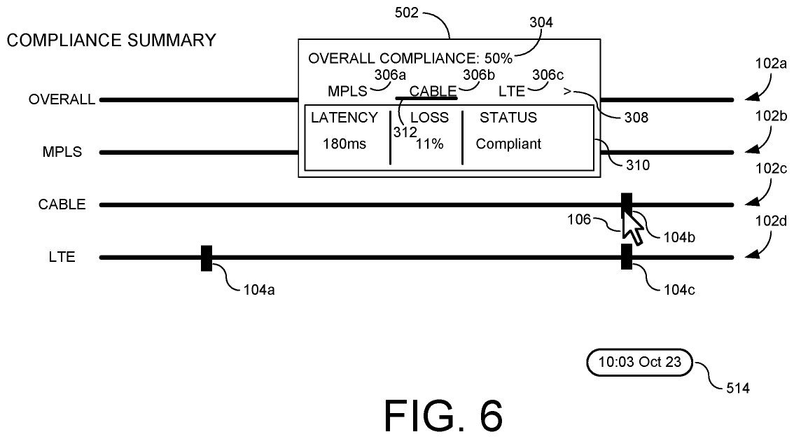

In some embodiments, markers 104 for multiple items 102 may be displayed at the same value of the dimension. In the example of FIG. 5, two markers 104b,c are displayed for the same time value of “10:03 Oct 23.” In particular, marker 104b is shown for the CABLE item 102c, while marker 104c is shown for the LTE item 102d. In such a case the user may switch tabs 306 by simply moving the cursor 106 to hover over a different marker 104. Such an example is illustrated in FIG. 6 according to embodiments of the disclosed technology.

Referring to FIG. 6, a user has moved the cursor 106 to hover over marker 104b, which represents CABLE item 102c. In response, the tooltip 502 indicates that the CABLE tab 104b is selected by displaying the indicator 312 at that tab, and displays the content for that tab in the content panel 310. In particular, the content indicates a latency of 180 milliseconds, a loss of 11%, and a status of “Compliant.” Because markers 104b,c represent the same time value, the time value shown at 514 remains unchanged.

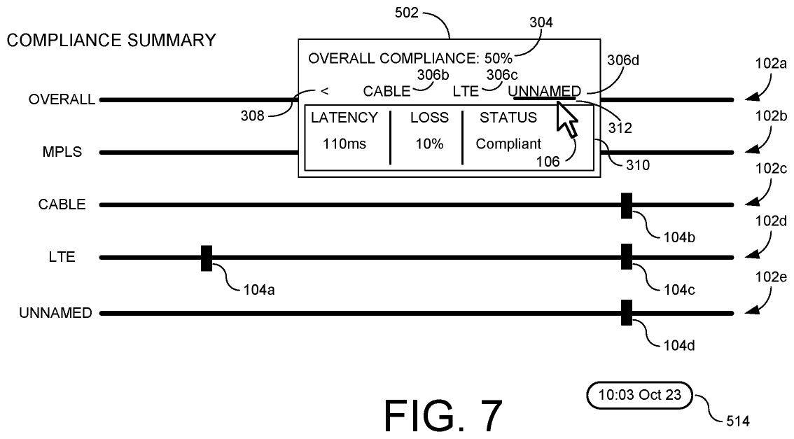

In some embodiments, for example when there are too many tabs to be shown in the small space available in a tooltip, the tooltip may display a tab control 308, as shown in FIG. 6. The user may operate the tab control 308 to scroll through all of the available tabs 306. FIG. 7 illustrates the image and tooltip of FIG. 6 after a user has operated the tab control 308 according to embodiments of the disclosed technology. Referring to FIG. 7, an additional tab 306d is displayed in the tooltip 502. In FIG. 7, the newly-displayed tab 306d is selected, as indicated by the indicator 312. The tab 306d may be selected by the user by hovering the cursor 106 over that tab. In some embodiments, the newly-displayed tab may be selected automatically when it is the only remaining tab to display. Responsive to the UNNAMED tab 306d being selected, content for that tab is displayed in the content pane 310. In particular, the content indicates a latency of 110 milliseconds, a loss of 10%, and a status of “Compliant.” And because no new marker 104 has been selected since the selection of marker 104b, the time value of the content remains unchanged, as shown at 514. The tab control 308 now appears at the left of the tooltip, to allow a user to scroll back through the tabs 306

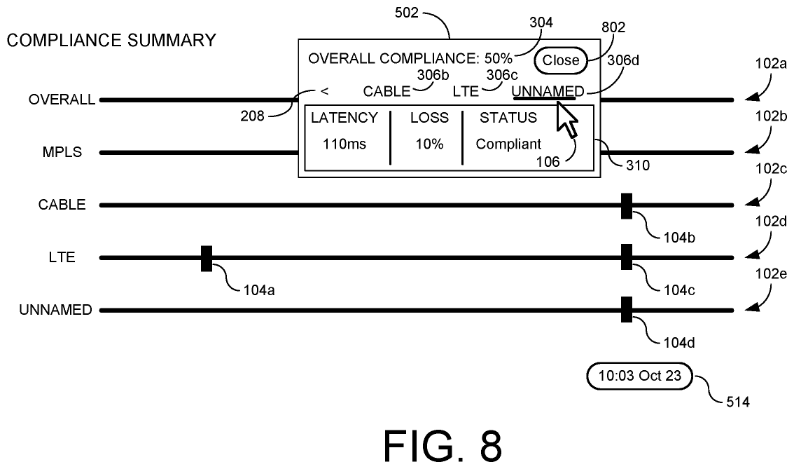

In some embodiments, the tooltip may include one or more action buttons, each associated with a respective action. FIG. 8 illustrates the tooltip 502 of FIG. 7, with the addition of an action button 802 that is labeled “Close,” and that is related to an action of closing the tooltip according to embodiments of the disclosed technology. That is, when a user manipulates the cursor 106 to select the close button 802, the tooltip 502 is no longer displayed. In some embodiments, the tooltip 502 closes automatically when the cursor 106 moves away from the tooltip, and remains away for a determined time.

Embodiments of the disclosed technology have been described above in the context of network performance. However, the disclosed navigable tooltips may be employed in any context. For example, consider a tool for designing environmentally-friendly buildings. The tool may display an image of a multi-story building, with a marker for each story. When a designer hovers the cursor over one of the markers, a navigable tooltip may appear. Each tab in the tooltip may represent one of the stories of the building, and the content panel for each tab may display data for that floor. In this example, the data may include building data related to environmental concerns. For example, the data may include power consumption data, heat generation data, emission data, and the like.

Based on this data, the designer may identify one of the stories of the building that is of particular environmental concern, and may use the tool to obtain a detailed view of that story. For example, the detailed view may include a number of powered devices, for example such as air-conditioning units, heaters, lighting systems, appliances, and the like. The tool may display a marker for each of the devices. When the designer hovers the cursor over one of the markers, another navigable tooltip may appear. The tabs in the tooltip may represent a number of alternatives that may be selected to implement the selected device. For example, each tab may represent a different product that could be purchased to implement the device, and the data shown in the content panel may relate to factors such as cost, size, and performance of the products.

As another example, the navigable tooltips may be used as part of a tool for designing an exascale computing center. In this example, a design tool may display a view of a server room that is part of the computing center. The view may include a number of computing nodes, each displayed with a respective marker. When a designer uses the tool to hover a cursor over one of the markers, a navigable tooltip may appear. Each tab in the navigable tooltip may relate to an aspect of the selected computing node. For example, one tab may relate to a computing performance of the node, while another tab may relate to a storage performance of the node, and another tab may relate to a power consumption of the node. When the designer selects the computing performance tab, data related to the computing performance of the selected node appears in the content panel of navigable tooltip. Similarly, when the designer then selects the storage performance tab, data related to the storage performance of the selected node appears in the content panel, replacing the data previously shown in the content panel. And when the designer selects the power consumption tab, data related to the power consumption of the selected node appears in the content panel.

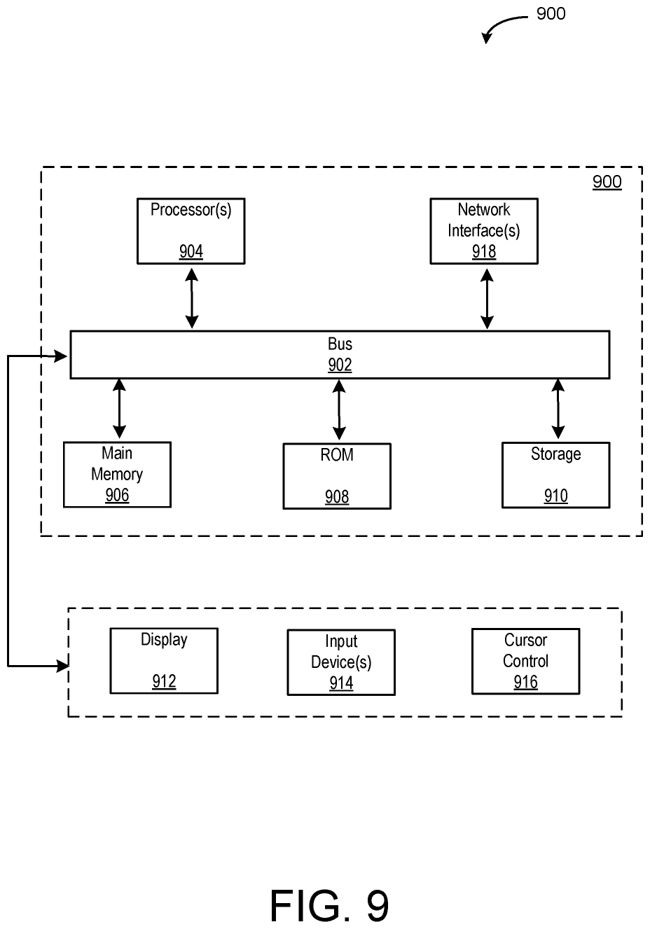

FIG. 9 depicts a block diagram of an example computer system 900 in which embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or a WAN component to communicate with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a hardware processor; and
a non-transitory machine-readable storage medium encoded with instructions executable by the hardware processor to perform a method comprising:
displaying an image in a graphical user interface, wherein the image comprises one or more markers;
responsive to detecting a cursor hovering over one of the markers, displaying a tooltip over a portion of the image, wherein the tooltip includes a plurality of tabs and a content panel, and wherein displaying the tooltip comprises displaying first content related to a first one of the tabs in the content panel; and
responsive to detecting the cursor hovering over a second one of the tabs, displaying second content related to the second one of the tabs in the content panel.

2. The system of claim 1, wherein displaying the second content related to the second one of the tabs in the content panel comprises:
replacing the first content related to the first one of the tabs with the second content related to the second one of the tabs.

3. The system of claim 1, wherein displaying the tooltip further comprises:
displaying a tab control in the tooltip; and
responsive to the tab control being selected, displaying one or more further tabs in the tooltip.

4. The system of claim 1, further comprising:
displaying an action button in the tooltip; and
responsive to the action button being selected, performing an action associated with the action button.

5. The system of claim 1, wherein:
the image includes a plurality of related items; and
each tab represents one of the items.

6. The system of claim 5, wherein:
the content related to each tab includes data associated with the item represented by the tab.

7. The system of claim 6, wherein:
data associated with the items varies along a common dimension;
each marker represents a value of the dimension; and
the content related to each tab for one of the markers includes data associated with the item represented by the tab for the value that is represented by the one of the markers.

8. A non-transitory machine-readable storage medium encoded with instructions executable by a hardware processor of a computing component, the machine-readable storage medium comprising instructions to cause the hardware processor to perform a method comprising:
displaying an image in a graphical user interface, wherein the image comprises one or more markers;
responsive to detecting a cursor hovering over one of the markers, displaying a tooltip over a portion of the image, wherein the tooltip includes a plurality of tabs and a content panel, and wherein displaying the tooltip comprises displaying first content related to a first one of the tabs in the content panel; and
responsive to detecting the cursor hovering over a second one of the tabs, displaying second content related to the second one of the tabs in the content panel.

9. The medium of claim 8, wherein displaying the second content related to the second one of the tabs in the content panel comprises:
replacing the first content related to the first one of the tabs with the second content related to the second one of the tabs.

10. The medium of claim 8, wherein displaying the tooltip further comprises:
displaying a tab control in the tooltip; and
responsive to the tab control being selected, displaying one or more further tabs in the tooltip.

11. The medium of claim 8, further comprising:
displaying an action button in the tooltip; and
responsive to the action button being selected, performing an action associated with the action button.

12. The medium of claim 8, wherein:
the image includes a plurality of related items; and
each tab represents one of the items.

13. The medium of claim 12, wherein:
the content related to each tab includes data associated with the item represented by the tab.

14. The medium of claim 13, wherein:
data associated with the items varies along a common dimension;
each marker represents a value of the dimension; and
the content related to each tab for one of the markers includes data associated with the item represented by the tab for the value that is represented by the one of the markers.

15. A method comprising:
displaying an image in a graphical user interface, wherein the image comprises one or more markers;
responsive to detecting a cursor hovering over one of the markers, displaying a tooltip over a portion of the image, wherein the tooltip includes a plurality of tabs and a content panel, and wherein displaying the tooltip comprises displaying first content related to a first one of the tabs in the content panel; and
responsive to detecting the cursor hovering over a second one of the tabs, displaying second content related to the second one of the tabs in the content panel.

16. The method of claim 15, wherein displaying the second content related to the second one of the tabs in the content panel comprises:
replacing the first content related to the first one of the tabs with the second content related to the second one of the tabs.

17. The method of claim 15, wherein displaying the tooltip further comprises:
displaying a tab control in the tooltip; and
responsive to the tab control being selected, displaying one or more further tabs in the tooltip.

18. The method of claim 15, further comprising:
displaying an action button in the tooltip; and
responsive to the action button being selected, performing an action associated with the action button.

19. The method of claim 15, wherein:
the image includes a plurality of related items; and
each tab represents one of the items.

20. The method of claim 19, wherein:
the content related to each tab includes data associated with the item represented by the tab;
data associated with the items varies along a common dimension;
each marker represents a value of the dimension; and
the content related to each tab for one of the markers includes data associated with the item represented by the tab for the value that is represented by the one of the markers.
